(19) United States
(12) Patent Application Publication
(10) Pub. No.: US 2015/0221097 A1
(43) Pub. Date: Aug. 6, 2015

(54) HARMLESS FRAME FILTER, HARMFUL IMAGE BLOCKING APPARATUS HAVING THE SAME, AND METHOD FOR FILTERING HARMLESS FRAMES

(71) Applicant: ELECTRONICS AND TELECOMMUNICATIONS RESEARCH INSITITUTE, Daejeon-city (KR)

(72) Inventors: Jung-Jae YU, Daejeon (KR); Seung-Wan HAN, Gwangju (KR); Moo-Seop KIM, Sejong (KR); Su-Gil CHOI, Daejeon (KR); Chi-Yoon JEONG, Daejeon (KR)

(73) Assignee: ELECTRONICS AND TELECOMMUNICATIONS RESEARCH INSTITUTE, Daejeon-city (KR)

(21) Appl. No.: 14/529,120

(22) Filed: Oct. 30, 2014

(30) Foreign Application Priority Data
Feb. 5, 2014 (KR) 10-2014-0013042

(51) Int. Cl. G06T 7/40; G06T 5/00; G06T 5/20; G06K 9/46

(52) U.S. Cl. CPC G06T 7/408; G06K 9/4642; G06K 9/4652; G06T 5/002; G06T 5/20; G06T 2207/10024; G06T 2207/20036; G06T 2207/20024; G06T 2207/20182; G06T 2207/30196

(57) ABSTRACT

Disclosed herein are a harmless frame filter, a harmful image blocking apparatus having the filter, and a method for filtering harmless frames, which can rapidly identify clearly harmless images and exclude those harmless images in advance upon determining harmful image content including obscene images in real time, thus improving task efficiency. The harmless frame filter includes a primary filtering unit for extracting skin region candidate pixels from an input image, and primarily filtering harmless frames, based on a ratio of the skin region candidate pixels to the input image, and a secondary filtering unit for generating a Block Binary Pattern (BBP) histogram representing distribution characteristics of the skin region candidate pixels in a two-dimensional (2D) image space, and secondarily filtering harmless frames by comparing predefined learning data with the BBP histogram.

### CROSS REFERENCE TO RELATED APPLICATION

This application claims the benefit of Korean Patent Application No. 10-2014-0013042 filed Feb. 5, 2014, which is hereby incorporated by reference in its entirety into this application.

### BACKGROUND OF THE INVENTION

1. Technical Field

The present invention relates generally to a harmless frame filter, a harmful image blocking apparatus having the filter, and a method for filtering harmless frames. More particularly, the present invention relates to a harmless frame filter, a harmful image blocking apparatus having the filter, and a method for filtering harmless frames, which can rapidly identify clearly harmless images and exclude those harmless images in advance upon determining harmful image content including obscene images in real time, thus improving task efficiency.

2. Description of the Related Art

With the development of communication network technology, and the popularization of PCs and mobile devices, downloading and viewing video content without temporal or spatial restrictions have recently become a part of the daily lives of people. However, with the increase in the convenience of entertainment culture, the risk of impressionable growing children and adolescents being exposed to harmful content such as obscene (or pornographic) videos has also increased.

Accordingly, the demand for technology for analyzing video content, automatically determining whether the video content is harmful, and blocking harmful content has increased.

Recent technical approaches to methods for determining and blocking harmful content are classified into several groups as follows.

The approach of the first group is to extract a specific color distribution region such as a skin region from an input image, and calculate the location of the center of gravity and feature vectors indicating the distribution forms of respective regions from a pixel set included in the skin region.

A recognizer such as a Multi-Layer Perceptron (MLP) and a Support Vector Machine (SVM) for receiving the feature vectors calculated in this way as input is trained so that it can determine whether an input image has harmfulness, that is, includes an obscene image.

Such an approach is a method that uses intuitive characteristics perceptible by human beings, who use preliminary knowledge indicating that harmful content images basically and frequently represent sexual acts by insufficiently-dressed persons.

The approach of the second group is to determine whether an input image is harmful by using statistical characteristics automatically extracted by machines. That is, this method is a method of applying a Bag Of Visual Word (BOVW) model that has been investigated to automatically select document contents to an image recognition problem, configuring a visual vocabulary dictionary from nature features automatically detected from the image, and automatically determining the category of each input image from the input image, as if the categories of the contents of the input document have been automatically recognized from the input document.

It has been reported in the academic world that if such a method is used, performance better than other conventional image recognition methods can be obtained upon detecting pornographic images, in which the sexual organs of a man and a woman are exposed, from input images.

However, such conventional research is intended to maximize the overall accuracy of computation results by minimizing both a False Positive Rate (FPR) and a False Negative Rate (FNR) upon determining whether input images have harmfulness.

However, in the stage of actually providing a required technology, it can be expected that from the standpoint of the proportion, the amount of time in which harmless content such as dramas, news and movies is played is much greater than the amount of time in which harmful content is played.

It is very inefficient, from the standpoint of reduction of a computational load on the system, to perform, in real time, harmfulness/harmlessness determination technology for producing precise harmfulness or harmlessness determination results while requiring a lot of computations in most of the time even when clearly harmless images are played. Therefore, there is required a fast harmless frame filtering technology which rapidly recognizes and excludes clearly harmless images via only simple and fast filtering computations, selects only images having a relatively strong possibility of being harmful, and transfers the selected images to a subsequent precise harmfulness/harmlessness determination engine, but effective research results have not yet been announced in this field.

Therefore, there are required a harmless frame filter, a harmful image blocking apparatus having the filter, and a method for filtering harmless frames, which can improve task efficiency by rapidly identifying clearly harmless images and by excluding those harmless images in advance upon determining harmful image content including obscene images in real time. As related technology, Korean Patent Application Publication No. 2012-0105821 is disclosed.

### SUMMARY OF THE INVENTION

Accordingly, the present invention has been made keeping in mind the above problems occurring in the prior art, and an object of the present invention is to rapidly determine clearly harmless images from a plurality of input frame images, exclude those images in advance, and select only images having a strong possibility of being harmful, thus improving the speed of harmfulness determination that is to be subsequently and precisely performed and reducing a burden on memory.

In accordance with an aspect of the present invention to accomplish the above object, there is provided a harmless frame filter, including a primary filtering unit for extracting skin region candidate pixels from an input image, and primarily filtering harmless frames, based on a ratio of the skin region candidate pixels to the input image, and a secondary filtering unit for generating a Block Binary Pattern (BBP) histogram representing distribution characteristics of the skin region candidate pixels in a two-dimensional (2D) image space, and secondarily filtering harmless frames by comparing predefined learning data with the BBP histogram.

The primary filtering unit may include a skin pixel extraction module for converting RGB color information at pixels of the input image into a Hue, Saturation, Value (HSV) color space to generate a hue histogram, and determining a maximum density region, in which a sum of densities is maximum on a predefined hue (H) channel of the hue histogram, to be a range of the skin region candidate pixels.

The primary filtering unit may further include a skin pixel-based primary filtering module configured to when the maximum density sum of the maximum density region is less than or equal to a first preset value, determine the input image to be a harmless image, and when the maximum density sum is greater than the first preset value, determine the input image to be a harmful candidate image, generate a binary alpha map from the skin region candidate pixels, and transfer the binary alpha map to the secondary filtering unit.

The secondary filtering unit may include a skin region post-processing module for performing post-processing on the alpha map and then generating a post-processed alpha map in which noise effects are corrected.

The skin region post-processing module may include an edge image generation sub-module for converting a color input image into a gray image, and generating an edge image using an edge operator, an edge sum image generation sub-module for generating an edge sum image, an edge density image generation sub-module for generating edge densities, an alpha map filtering sub-module for determining pixels, edge densities of which are equal to or greater than a second preset value in the alpha map, to be a background region, and modifying the alpha map, and a morphological operation sub-module for reducing noise of the alpha map by sequentially applying morphological closing and opening operations of the edge operator.

The secondary filtering unit may further include a BBP histogram generation module for extracting, from the post-processed alpha map, distribution characteristics of skin pixels extracted from a human skin on an image plane, wherein the distribution characteristics of the skin pixels are differentiated from those of skin color pixels of a background region mistaken for the skin region due to similarity to a skin color.

The BBP histogram generation module may include an alpha map block matrix generation sub-module for dividing the post-processed alpha map into image blocks formed as a predetermined number of matrices, and classifying each division image block as a skin image block or a non-skin image block, based on a ratio of skin pixels to the division image block, a BBP matching sub-module for representing, based on the skin image block, a distribution form of the skin image block with respect to neighboring image blocks by 51 non-overlapping BBPs, by means of a BBP block rotational transform and a BBP array direction inverse transform, and a BBP histogram generation sub-module for detecting a number of BBPs represented by the BBP matching sub-module and then generating a BBP histogram.

The BBP matching sub-module may represent 51 BBPs within a range of an alpha map having division image blocks, each BBP being represented by a 3×3 matrix in which an element corresponding to a second row and a second column is a skin image block.

The secondary filtering unit may include a BBP-based secondary filtering module for designating the BBP histogram as a feature vector having a spatial dimension of 51, and comparing the feature vector as the predefined learning data based on K-means clustering or a Support Vector Machine (SVM), thus secondarily filtering harmless frames.

In accordance with another aspect of the present invention to accomplish the above object, there is provided a harmful image blocking apparatus, including a harmfulness determination unit for determining, for filtered input images obtained by filtering harmless frames using a harmless frame filter, whether the filtered input images are harmful images, based on learning data stored in a harmful content preliminary knowledge database (DB), and a harmful image blocking unit for accumulating and aggregating results of determination performed by the harmfulness determination unit about whether the filtered input images are harmful images on a time axis, finally determining whether an image currently being played is a harmful image, and blocking the image if it is determined that the image is a harmful image.

In accordance with a further aspect of the present invention to accomplish the above object, there is a method of filtering harmless frames, including performing, by a primary filtering unit, primary filtering by extracting skin region candidate pixels from an input image, and by primarily filtering harmless frames, based on a ratio of the skin region candidate pixels to the input image, and performing, by a secondary filtering unit, secondary filtering by generating a Block Binary Pattern (BBP) histogram representing distribution characteristics of the skin region candidate pixels in a two-dimensional (2D) image space, and by comparing predefined learning data with the BBP histogram to secondarily filter harmless frames.

Performing the primary filtering may include performing skin pixel extraction by converting RGB color information at pixels of the input image into a Hue, Saturation, Value (HSV) color space to generate a hue histogram and by determining a maximum density region, in which a sum of densities is maximum on a predefined hue (H) channel of the hue histogram, to be a range of the skin region candidate pixels.

Performing the primary filtering may further include, after performing the skin pixel extraction, performing skin pixel-based primary filtering by when the maximum density sum of the maximum density region is less than or equal to a first preset value, determining the input image to be a harmless image, and when the maximum density sum is greater than the first preset value, determining the input image to be a harmful candidate image, and generating a binary alpha map from the skin region candidate pixels.

Performing the secondary filtering may include performing skin region post-processing by performing post-processing on the generated alpha map, and then generating a post-processed alpha map in which noise effects are corrected.

Performing the skin region post-processing may include converting a color input image into a gray image, and generating an edge image using an edge operator, generating an edge sum image, generating edge densities, determining pixels, edge densities of which are equal to or greater than a second preset value in the alpha map, to be a background region, and then modifying the alpha map, and reducing noise of the alpha map by sequentially applying morphological closing and opening operations of the edge operator.

Performing the secondary filtering may further include, after performing the skin region post-processing, performing BBP histogram generation by extracting, from the post-processed alpha map, distribution characteristics of skin pixels extracted from a human skin on an image plane, wherein the distribution characteristics of the skin pixels are differentiated from those of skin color pixels of a background region mistaken for the skin region due to similarity to a skin color.

Performing the BBP histogram generation may include dividing the post-processed alpha map into image blocks formed as a predetermined number of matrices, and classifying each division image block as a skin image block or a non-skin image block, based on a ratio of skin pixels to the division image block, representing, based on the skin image block, a distribution form of the skin image block with respect to neighboring image blocks by 51 non-overlapping BBPs, by means of a BBP block rotational transform and a BBP array direction inverse transform, and detecting a number of represented BBPs and then generating a BBP histogram.

Representing the distribution form may include representing 51 BBPs within a range of an alpha map having division image blocks, each BBP being represented by a 3×3 matrix in which an element corresponding to a second row and a second column is a skin image block.

Performing the secondary filtering may include, after generating the BBP histogram, designating the BBP histogram as a feature vector having a spatial dimension of 51, and comparing the feature vector as the predefined learning data based on K-means clustering or a Support Vector Machine (SVM), thus secondarily filtering harmless frames.

The method may further include, after performing the secondary filtering, determining, for filtered input images, obtained by performing the secondary filtering, whether the filtered input images are harmful images, based on learning data stored in a harmful content preliminary knowledge database (DB), and accumulating and aggregating results of the determination about whether the filtered input images are harmful images on a time axis, finally determining whether an image currently being played is a harmful image, and blocking the image if it is determined that the image is a harmful image.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a system configuration diagram of a harmless frame filter and a harmful image blocking apparatus according to the present invention;

FIG. 2 is a block diagram showing a harmless frame filter according to the present invention;

FIG. 3 is a diagram showing the primary filtering unit and the secondary filtering unit of the harmless frame filter according to the present invention;

FIG. 4 is a diagram showing the skin region post-processing module of the secondary filtering unit;

FIG. 5 is a diagram showing the BBP histogram generation module of the secondary filtering unit;

FIGS. 6 and 7 are diagrams showing the hue histogram of a harmful image;

FIGS. 8 and 9 are diagrams showing the hue histogram of a harmless image;

FIG. 10 is a diagram showing the maximum density sum of the hue histogram of the harmful image;

FIG. 11 is a diagram showing the maximum density sum of the hue histogram of the harmless image;

FIG. 12 is a diagram showing a case where an input image is a harmless image;

FIG. 13A and 13B are diagrams showing the comparison of the results of extraction of skin pixels between the present invention and prior art;

FIG. 14 is a diagram showing a state before a skin region is extracted from a harmless image;

FIG. 15 is a diagram showing a state in which a skin region has been extracted from a harmless image;

FIG. 16 is a diagram showing the inverse transform of a BBP array direction;

FIG. 17 is a diagram showing the invariant property of the rotational transform of a BBP block and the inverse transform of a BBP array direction;

FIG. 18 is a diagram showing LBP samples regarded as non-identical;

FIGS. 19 to 21 are diagrams showing 51 BBPs proposed in the present invention;

FIG. 22 is a flowchart showing a method of filtering harmless frames according to the present invention; and

FIGS. 23 and 24 are diagrams showing embodiments of a method for filtering harmless frames according to the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below.

The embodiments of the present invention are intended to fully describe the present invention to a person having ordinary knowledge in the art to which the present invention pertains. Accordingly, the shapes, sizes, etc. of components in the drawings may be exaggerated to make the description clearer.

Further, in the description of the components of the present invention, the terms such as first, second, A, B, (a), and (b) may be used. Such terms are merely intended to distinguish a specific component from other components and are not intended to limit the essential features, order, or sequential position of the corresponding component.

Hereinafter, a system configuration diagram of a harmless frame filter and a harmful image blocking apparatus according to the present invention to accomplish the above objects will be described in detail.

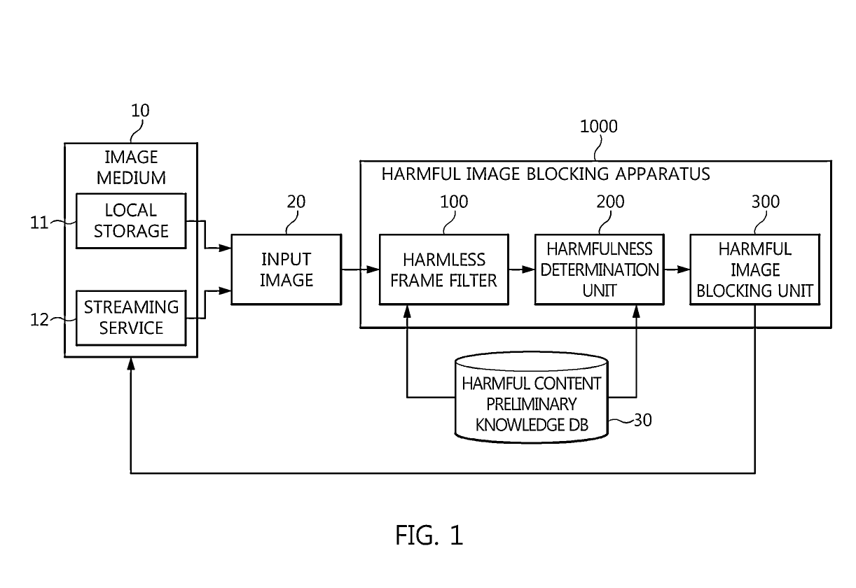

FIG. 1 is a system configuration diagram of a harmless frame filter and a harmful image blocking apparatus according to the present invention.

The term “harmful image” denotes an obscene (pornographic) video in which the sexual organs of a man and a woman are exposed, or in which sexual acts or similar acts are frequently depicted. In contrast, harmful candidate images denote all images in which the ratio of an exposed skin region to the total image size is greater than a predetermined ratio and which the property of an approximate shape of an image is suspectible to be harmful. Generally, harmful candidate images inclusively have not only the above-described harmful images, but also images of persons in swimming suits, videos corresponding to underwear commercial films (CFs), performance videos of entertainers wearing skimpy clothes, etc.

Generally, when the performance of technology for determining harmful images and harmless images is described, a target image denotes the above-described harmful image, but a target image in the harmless frame filter according to the present invention, which will be described later, includes all harmful candidate images including harmful images.

A skin region, which will be described later upon extracting the characteristics of color distribution of harmful candidate images, denotes an area which is included in an exposed skin region of a person in each input image, and a background region denotes all regions other than the skin region in the input image.

Referring to FIG. 1, a harmless frame filter 100 according to the present invention corresponds to a part of a harmful image blocking apparatus 1000 according to the present invention, which further includes a harmfulness determination unit 200 and a harmful image blocking unit 300 in addition to the harmless frame filter 100. The harmless frame filter 100 first filters an image having a strong possibility of being a harmless frame in the first stage of the harmful image blocking apparatus 1000.

That is, before the harmfulness determination unit 200 precisely determines an input image 20, the harmless frame filter 100 previously filters frames determined to be harmless images, thus improving the task speed of the harmfulness determination unit 200 and preventing an overload of memory.

In detail, the harmful image blocking apparatus 1000 according to the present invention includes the harmfulness determination unit 200 and the harmful image blocking unit 300. The harmfulness determination unit 200 determines whether each filtered input image acquired by filtering harmless frames through the harmless frame filter 100 according to the present invention is a harmful image, based on learning data stored in a harmful content preliminary knowledge database (DB) 30. The harmful image blocking unit 300 accumulates and aggregates the results of determining whether filtered input images are harmful images via the harmfulness determination unit 200, on a time axis, finally determines whether a video currently being played is a harmful video, and blocks the video currently being played if it is determined that the video is a harmful video.

Here, the term “filtered input image” denotes each image obtained by passing the input image 20 through the harmless frame filter 100 according to the present invention and removing harmless frames from the input image 20. That is, the image before passing through the harmless frame filter 100 is called an “input image 20”, and the image having passed through the harmless frame filter 100 is called a “filtered input image.”

More specifically, all frame images are input to the harmless frame filter 100 while a video is being played from an image medium 10 such as local storage 11 or a real-time streaming service 12. The harmless frame filter 100 filters, that is, blocks, all input frame images that are clearly harmless, selects only harmful candidate images suspected to be harmful, and transfers the selected harmful candidate images to the harmfulness determination unit 200.

The harmfulness determination unit 200 precisely determines whether filtered input images selected as harmful candidate images after passing through the harmless frame filter 100 have harmfulness, using more precise image recognition technology, and transfers the results of the determination to the harmful image blocking unit 300.

The harmful image blocking unit 300 accumulates and aggregates the results of the determination of harmfulness or harmlessness, received from the harmfulness determination unit 200, on the time axis, finally determines whether the video currently being played is harmful, and discontinues playing the video from the image medium 10 if it is determined that the video is harmful content, thus preventing the user from viewing the harmful content.

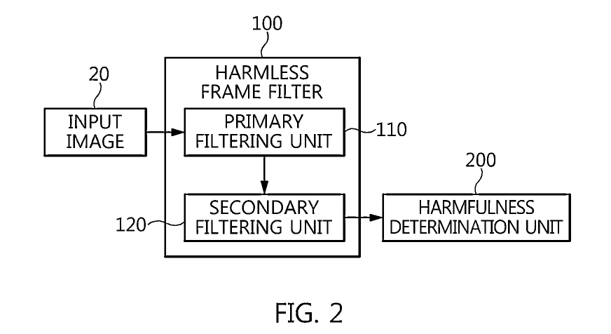

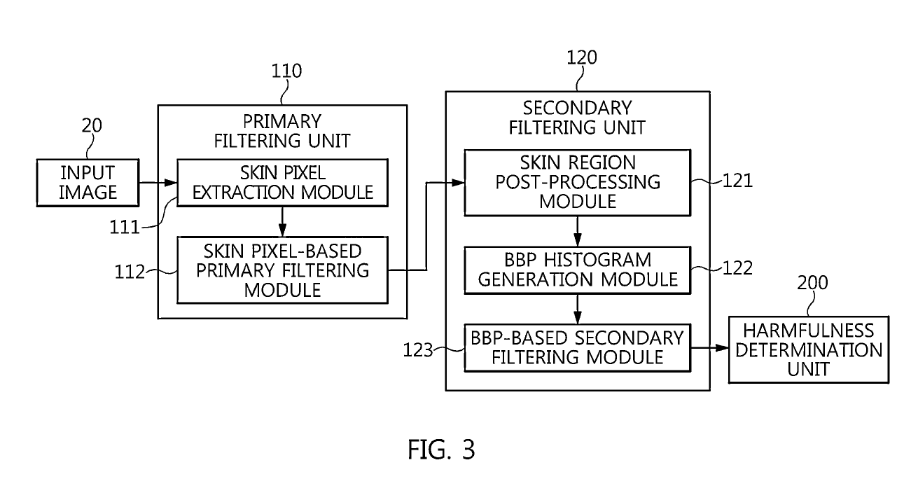

Below, the harmless frame filter according to the present invention will be described in detail with the attached drawings. FIG. 2 is a block diagram showing the harmless frame filter according to the present invention. FIG. 3 is a diagram showing the primary filtering unit and the secondary filtering unit of the harmless frame filter according to the present invention.

Referring to FIG. 2, the harmless frame filter 100 according to the present invention includes a primary filtering unit 110 and a secondary filtering unit 120.

The primary filtering unit 110 primarily filters and removes harmless frames from the input image 20, and the secondary filtering unit 120 secondarily filters and removes harmless frames from the filtered input image.

More specifically, the primary filtering unit 110 functions to extract skin region candidate pixels from the input image 20, and to primarily filter harmless frames, based on the ratio of the skin region candidate pixels to the input image. The secondary filtering unit 120 functions to generate a Block Binary Pattern (BBP) histogram representing the distribution characteristics of the skin region candidate pixels in a 2D image space, and secondarily filter harmless frames by comparing predefined learning data with the histogram.

If the input image 20 has been filtered by the secondary filtering unit 120, the filtered input image is transferred to the harmfulness determination unit 200.

That is, the harmless frame filter 100 according to the present invention performs a primary filtering step which primarily utilizes the results of extraction of harmless frame skin pixels via the primary filtering unit 110, and a secondary filtering step which uses the distribution characteristics of a skin region in a 2D image area via the secondary filtering unit 120.

The primary filtering step is performed such that, based on the assumption that harmful candidate images include skin region pixels above a predetermined rate, skin region candidate pixels having a strong possibility of belonging to a skin region are extracted using a method adaptive to the input image, and such that, if the ratio of the total number of the skin region candidate pixels to the total number of pixels of the entire image is equal to or greater than a predetermined rate, the input image is considered to be a primary harmful candidate image, whereas if the ratio is less than the predetermined rate, the input image is considered to be a harmless image.

The secondary filtering step is configured such that, based on the assumption that, in the form of the distribution of skin region pixels of the harmful candidate image in the 2D image space, slight statistical characteristics are present, frame images having a strong possibility of being harmless are filtered again and removed from primary harmful candidate images having passed through the primary filtering step, and then final harmful candidate images are extracted.

The principle of filtering harmless frames at this step is described using an intuitive example. That is, no matter how many skin region candidate pixels are detected, if the candidate pixels are scattered and distributed in a shape similar to that of salt-and-pepper noise in the 2D image space, a case where those pixels have a high probability of being pixels detected from a background region having a color similar to skin color area rather than being pixels detected from an actual skin region and where a possibility that the input image will be a harmful image is estimated to be low may be taken into consideration.

In order to implement such a concept, a skin region in which noise effects are corrected via a post-processing procedure is estimated from skin region candidate pixels extracted at the above-described primary filtering step, a BBP histogram representing the characteristics of the distribution of the skin region in the 2D image space is calculated and compared with learning data, only harmful candidate images are selected, and the results of selection are transferred to the subsequent harmfulness determination unit.

Below, the operation and configuration of the primary filtering unit 110 and the secondary filtering unit 120 will be described in greater detail with reference to FIG. 3. The primary filtering unit 110 includes a skin pixel extraction module 111 and a skin pixel-based primary filtering module 112.

Further, the secondary filtering unit 120 includes a skin region post-processing module 121, a Block Binary Pattern (BBP) histogram generation module 122, and a BBP-based secondary filtering module 123.

The skin pixel extraction module 111 functions to convert RGB color information at pixels of the input image into an HSV (hue, saturation, value) color space, generate a hue histogram, and determine a maximum density region, in which the sum of densities is maximum on a preset color (hue: H) channel of the hue histogram, to be the range of the skin region candidate pixels.

Further, the skin pixel-based primary filtering module 112 functions to, if the maximum density sum of the maximum density region is less than or equal to a first preset value, determine the input image to be a harmless image, and if the maximum density sum is greater than the first preset value, determine the input image to be a harmful candidate image, generate a binary alpha map from the skin region candidate pixels, and transfer the alpha map to the secondary filtering unit 120.

Below, the operation of the skin pixel extraction module 111 and the skin pixel-based primary filtering module 112 of the primary filtering unit 110 will be described in detail with reference to the attached drawings.

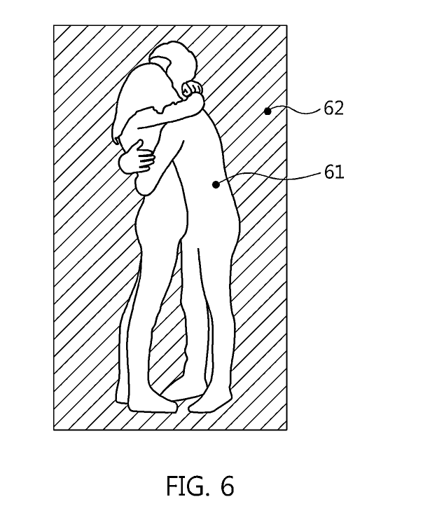

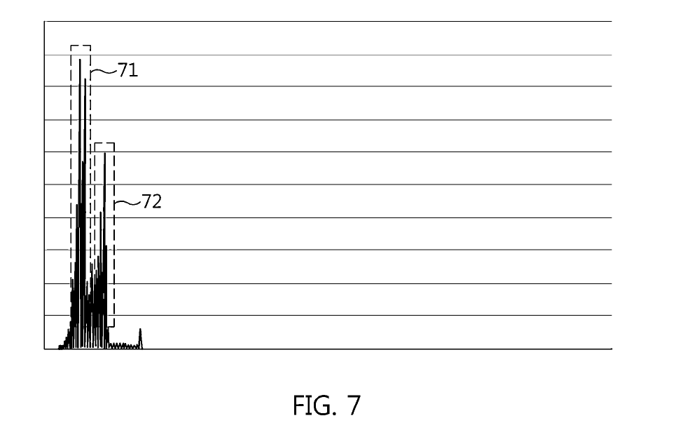

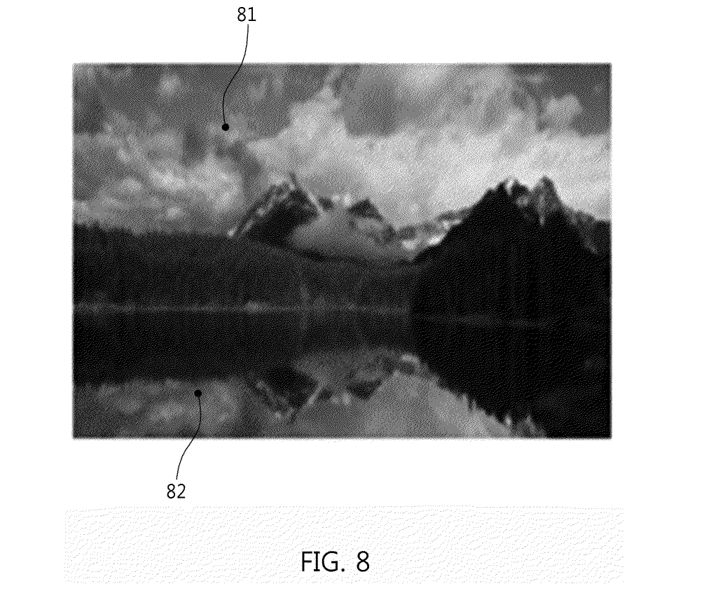

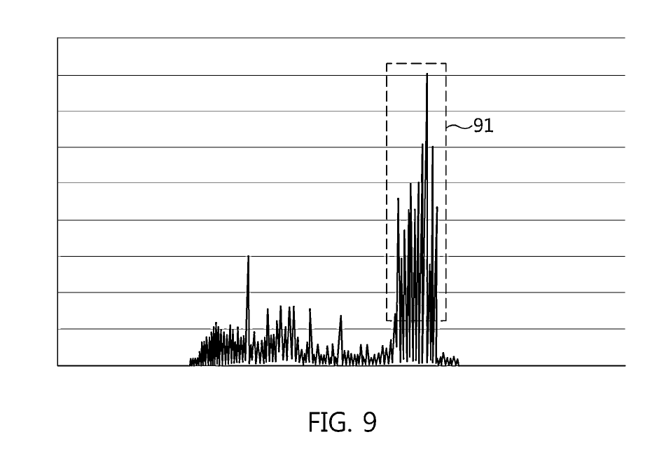

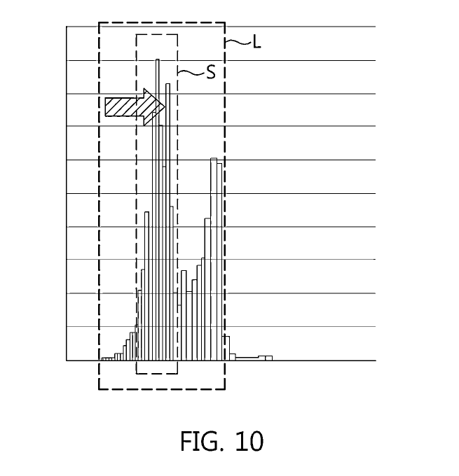

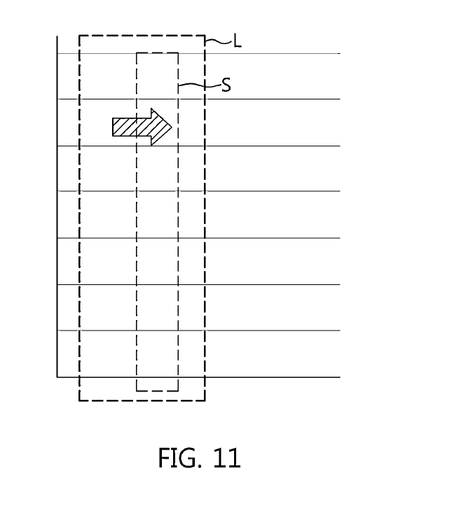

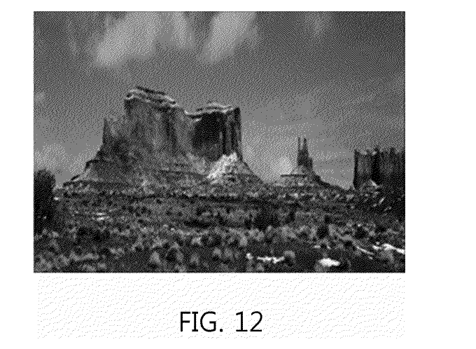

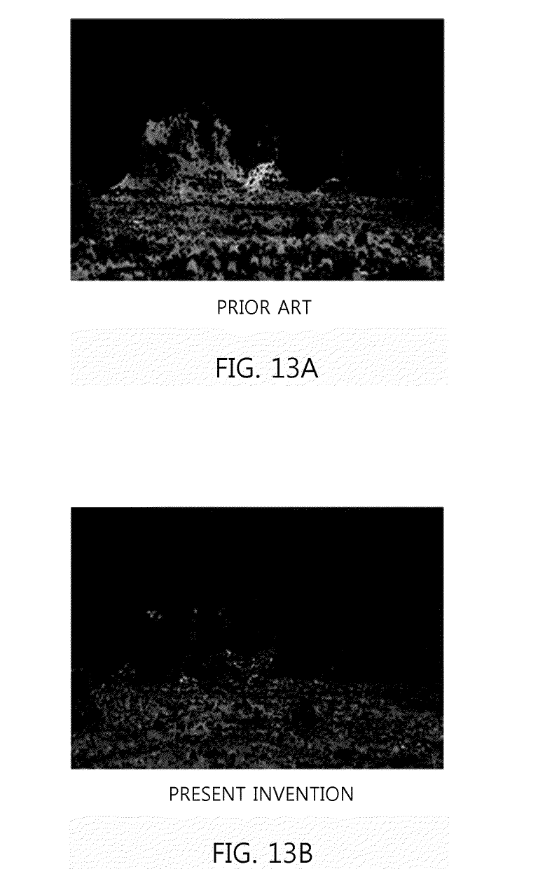

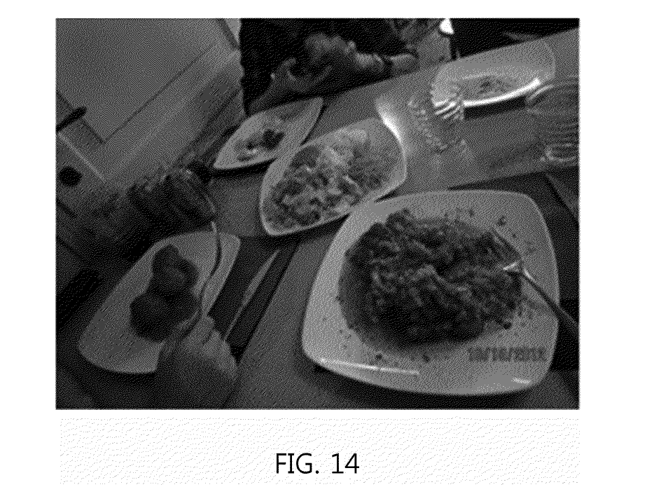

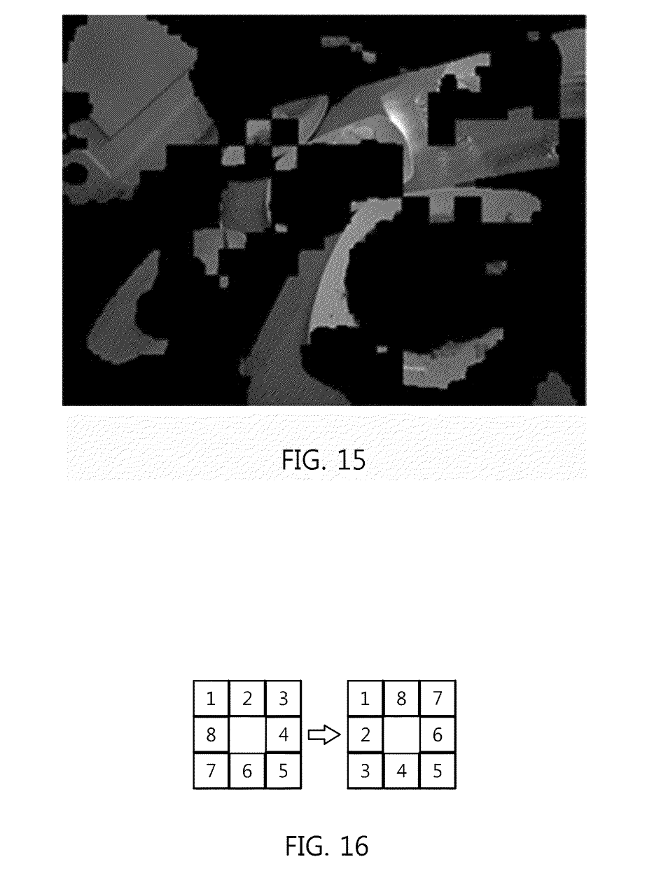

FIGS. 6 and 7 are diagrams showing the hue histogram of a harmful image. FIGS. 8 and 9 are diagrams showing the hue histogram of a harmless image. FIG. 10 is a diagram showing the maximum density sum of the hue histogram of the harmful image. FIG. 11 is a diagram showing the maximum density sum of the hue histogram of the harmless image. FIG. 12 is a diagram showing a case where an input image is a harmless image. FIG. 13A and 13B are diagrams showing the comparison of the results of extraction of skin pixels between the present invention and prior art. FIG. 14 is a diagram showing a state before a skin region is extracted from a harmless image. FIG. 15 is a diagram showing a state in which a skin region has been extracted from a harmless image.

The skin pixel extraction module 111 converts RGB color information at individual pixels of the input image 20 into an HSV color space, and determines the range of skin region candidate pixels on the color (hue, hereinafter referred to as “H”) channel. A method of identifying skin region pixels in the HSV color space using H values enables the extraction of a skin region robust to a variation in a lighting condition and a variation in an entire image tone. A conventional method for extracting a skin region from the HSV color space regards all pixels having H values, which fall within a fixed specific range, as skin region pixels, based on preliminary knowledge of harmful content images (see “A New Skin Detection Approach for Adult Image Identification,” A. N. Ghomsheh, RJASET 2012).

That is, a method of considering all pixels, H values of which range from predefined Hₘᵢₙ to Hₘₐₓ, based on the predefined Hₘᵢₙ and Hₘₐₓ, to be skin region pixels can be implemented.

However, such an approach is problematic in that, in order to detect all skin region pixels within the image, the range from Hₘᵢₙ to Hₘₐₓ must be set to a wide area, and in that case a large number of pixels in a region having colors similar to a skin color are detected from a background region.

In order to solve such a problem, a method of adaptively determining the range from Hₘᵢₙ to Hₘₐₓ in which pixels are considered to be skin color pixels depending on the type of input image is proposed. The basic premise employed in the proposed method means an assumption that, when an input image is a harmful image, an H histogram for the input image has characteristics that a kernel region, in which densities are concentrated in a narrow range, is observed in a predefined wide color candidate region ranging from H_{wide min} to H_{wide max} when the H histogram for the input image is calculated.

Such an assumption relatively desirably conforms to the case where the input image is limited to a commercial obscene video rather than a still nude picture containing artistic characteristics imparted by a photographer.

Referring to FIG. 6, a harmful image can be seen. In FIG. 6, a skin region 61 in a skin color and a background region 62 in a yellow color are present together. A hue histogram of such a harmful image is shown in FIG. 7. Referring to FIG. 7, it can be seen that the hue histogram has a distribution with two peaks 71 and 72 in a range of 10 to 40.

Referring to FIG. 8, a harmless image can be seen. In FIG. 8, a sky region 81 in a blue color and a lake region 82 in a blue color are present together. A hue histogram for such a harmless image is illustrated in FIG. 9. Referring to FIG. 9, it can be seen that the hue histogram of the harmless image exhibits a density concentrated in an H region corresponding to the blue color due to the sky region 81 and the lake region 82 while being distributed wider than the hue histogram of the harmful image.

In the case where it is assumed that pixels falling within the fixed range from Hₘᵢₙ to Hₘₐₓ are skin region pixels in the harmful image, as in the case of the conventional method, if the range from Hₘᵢₙ to Hₘₐₓ is fixed widely, the overall yellow background region 62 will be mistaken for a skin region and erroneously detected.

If the range from Hₘᵢₙ to Hₘₐₓ is fixed narrowly to prevent such an erroneous detection, the distribution of a skin color that varies with images may not be sufficiently covered, and only a part of the skin region may be detected.

Therefore, the skin pixel extraction module 111 generates a hue histogram by converting RGB color information at the pixels of the input image 20 into an HSV color space, and then determines the maximum density region, in which the sum of densities is maximum on a predefined color (H: hue) channel of the hue histogram, to be the range of the skin region candidate pixels.

More specifically, referring to FIGS. 10 and 11, a procedure for searching a harmful image received as an input for a location at which the sum of H histogram values (hereinafter referred to as a ‘density sum’) within a narrow window represented by a small dotted line box (S) is maximum is performed while moving the narrow window in a wide color distribution candidate region ranging from H_{wide min} to H_{wide max} represented by a large dotted line box (L).

That is, the sum of densities within the narrow window at each location is calculated while moving the center of the narrow window (S) in the wide skin color candidate range from H_{wide min} toH_{wide max}, and the location where the sum of densities is maximum is searched for.

In FIG. 10, since the input image is a harmful image, the skin region can be detected. In contrast, FIG. 11 shows an example in which the input image is a harmless image, and thus the maximum value of the sum of densities is calculated as a very small value even if the maximum value of the sum of densities is searched for while moving the narrow window. In the above examples, the range from H_{wide min} to H_{wide max} was set to a range from 10 to 40, and the size of the narrow window was set to 7. A reference value for determining whether an input image is a harmful candidate image, with respect to the maximum density sum, is determined at a learning step which will be described later.

If the maximum density sum calculated in the above procedure is equal to or greater than a predetermined reference value, the skin pixel-based primary filtering module 112 regards the input image as a primary harmful candidate image, generates a binary alpha map from the extracted skin region pixels, and transfers the alpha map to the skin region post-processing module 121 of the secondary filtering unit 120 to allow a secondary filtering step to be performed. In contrast, if the maximum density sum is less than the predetermined reference value, the skin pixel-based primary filtering module 112 regards the input image as a harmless image and does not perform operations of subsequent modules, and may notify the harmfulness determination unit 200 that the current input image is the harmless image.

Referring to FIGS. 12 and 13A and 13B, the results of extraction of skin pixels can be seen via the comparison between prior art and the present invention.

FIG. 12 illustrates an original input image, and FIG. 13A and 13B are diagrams showing the comparison of the results of extraction of skin pixels for the original input image shown in FIG. 12 between the prior art and the present invention.

In detail, FIG. 13A and 13B are diagrams showing the results of extraction of skin pixels when a harmless image is received an input image in the case where the method of the present invention is used and where a conventional method of regarding pixels, the hue values of which fall within the fixed range from Hₘᵢₙ to Hₘₐₓ, as skin pixels is used.

Pixels estimated to be those of a skin are represented by the original color of the input image, and pixels other than the skin-estimated pixels are changed to be colored in black, and thus the results of extraction of skin pixels are represented. As shown in FIG. 13A and 13B, it can be seen that when the method of the present invention is used, the number of pixels erroneously detected as skin pixels in the harmless image is smaller than that obtained when the prior art is used, thus enabling the skin pixel-based primary filtering module 120 to improve the precision of filtering results.

When harmless frames are filtered depending on the rate of skin pixels at the primary filtering step by the primary filtering unit 110, a large number of harmless frames are filtered, but harmless images containing a large number of pixels in a color similar to a skin color are not filtered and are erroneously recognized as harmful candidate images even if the harmless images do not include actual skin regions.

This is a problem occurring because the location information of pixels on the image plane at the primary filtering step is not taken into consideration, and only statistical distribution information in a color space is used.

At the secondary filtering step by the secondary filtering unit 120, such a problem is partially solved by considering both the distribution in the color space and the distribution information of skin pixels on the image plane.

FIG. 14 illustrates an example of a harmless image including a large number of pixels in a color similar to a skin color, and FIG. 15 illustrates an example in which only colors of pixels estimated to be skin pixels are visualized after post-processing has been performed via the skin region post-processing module 121 of the secondary filtering unit 120.

As shown in the drawing, it can be seen that pixels estimated to be those of a skin region in a harmless image are fragmentarily disconnected and distributed over a relatively wide area, compared to the skin pixels of a harmful image. However, in relation to the distribution of skin pixels, when harmfulness or harmlessness is simply determined only based on quantified density in the image plane, if the region of skin pixels is separated and detected, there is a concern that the input image may be mistaken for a harmful image.

Therefore, at the secondary filtering step performed by the secondary filtering unit 120, there is a need to previously model the skin pixel distribution characteristics of a harmless image group and a harmful image group for learning data, and additionally filter harmless images, which were mistaken for harmful candidate images at the primary filtering step, using such models. However, a recognition method at this time must be able to rapidly filter clearly harmless input images using a more compact method, unlike the conventional method of matching feature points and extracting the statistical characteristics at pixel levels.

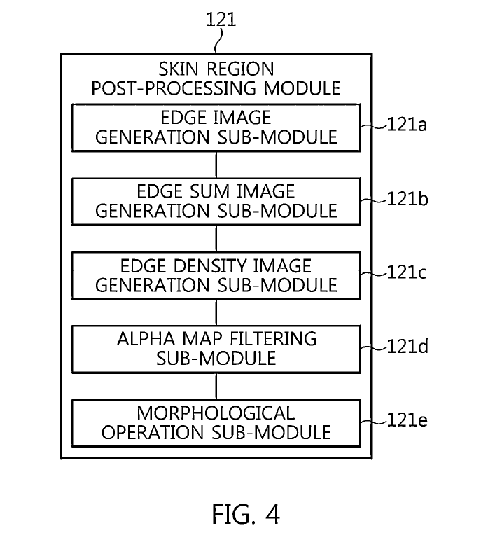

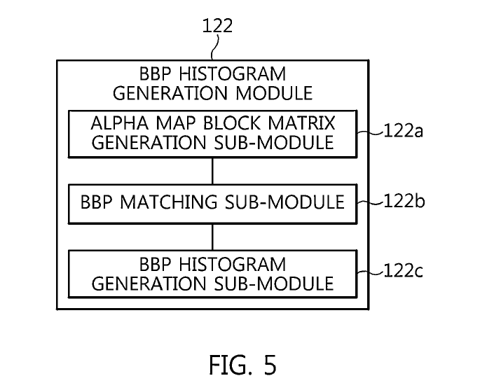

Below, the operation of the skin region post-processing module 121, the BBP histogram generation module 122, and the BBP-based secondary filtering module 123 of the secondary filtering unit 120 will be described in greater detail with reference to the attached drawings. FIG. 4 is a diagram showing the skin region post-processing module of the secondary filtering unit. FIG. 5 is a diagram showing the BBP histogram generation module of the secondary filtering unit.

Referring to FIG. 4, the skin region post-processing module 121 functions to generate a post-processed alpha map in which noise effects are corrected by performing post-processing on the alpha map, and includes an edge image generation sub-module 121a, an edge sum image generation sub-module 121b, an edge density image generation sub-module 121c, an alpha map filtering sub-module 121d, and a morphological operation sub-module 121e.

In detail, the edge image generation sub-module 121a of the skin region post-processing module 121 converts a color input image into a gray image and generates an edge image using an edge operator. The edge sum image generation sub-module 121b generates an edge sum image, and the edge density image generation sub-module 121c generates edge densities. The alpha map filtering sub-module 121d determines pixels, the edge densities of which are equal to or greater than a second preset value in the alpha map, to be a background region, and then modifies the alpha map. The morphological operation sub-module 121e reduces the noise of the alpha map by sequentially applying the morphological closing and opening operations of the edge operator to the alpha map.

The edge image generation sub-module 121a converts a color input image into a gray image, and generates an edge image E using an edge operator such as a Sobel operator. The edge sum image generation sub-module 121b generates an edge sum image Eₛᵤₘ using the following Equation (1), and the edge density image generation sub-module 121c generates an edge density image E_{dns} using the following Equation (2):

$$\begin{matrix}{E}_{sum} ( u , v ) = {\sum }_{i = 0}^{u - 1} {\sum }_{j = 0}^{v - 1} E ( i , j ) & ( 1 ) \\ \begin{matrix}{E}_{dns} ( u , v ) = \frac{1}{N} {\sum }_{i = u - w}^{u + w} {\sum }_{j = v - w}^{v + w} E ( i , j ) \\ = \frac{1}{N} ( {E}_{sum} ( u + w , v + w ) + {E}_{sum} ( u - w , v - w ) - \\ {E}_{sum} ( u + w , v - w ) - {E}_{sum} ( u - w , v + w )\end{matrix} \\ when N = {( 2 w + 1 )}^{2} & ( 2 )\end{matrix}$$

Further, the alpha map filtering sub-module 121d considers pixels, the edge densities of which are equal to or greater than a predetermined value in the skin pixel alpha map obtained at the primary filtering step by the above-described primary filtering unit 110, to be the background region, and then modifies the skin pixel alpha map. The morphological operation sub-module 121e reduces noise effects in the skin pixel alpha map by sequentially applying morphological closing and opening operations.

In this case, the edge image is the result of the edge image generation sub-module 121a, and the edge density image is an image in which pixels, the densities of which are equal to or greater than a predetermined value, are represented by 255 and the remaining pixels are represented by 0, in the result of the edge density image generation sub-module 121c. That is, the skin region represents the color values of an original image, and the background region is set to ‘0’ using the alpha map obtained as the final results of the skin region post-processing module 121.

Referring to FIG. 5, the BBP histogram generation module 122 includes an alpha map block matrix generation sub-module 122a, a BBP matching sub-module 122b, and a BBP histogram generation sub-module 122c.

More specifically, the BBP histogram generation module 122 functions to extract, from the post-processed alpha map, the distribution characteristics of skin pixels extracted from a human skin on an image plane, wherein the distribution characteristics of the skin pixels are differentiated from those of skin color pixels of a background region mistaken for the skin region due to similarity to a skin color.

Further, the alpha map block matrix generation sub-module 122a divides the post-processed alpha map into image blocks which are formed as a predetermined number of matrices, and classifies each division image block as a skin image block or a non-skin image block, based on the ratio of skin pixels to the division image block. Based on each skin image block in the alpha map block matrix, the BBP matching sub-module 122b represents the distribution form of the corresponding skin image block with respect to neighboring image blocks by 51 non-overlapping BBPs, by means of a BBP block rotational transform and a BBP array direction inverse transform. The BBP histogram generation sub-module 122c detects the number of BBPs represented by the BBP matching sub-module 122b and then generates a BBP histogram.

The alpha map block matrix generation sub-module 122a divides a skin pixel alpha map image into M×N (width×height) image blocks (20×20 in the embodiment), regards each image block as a skin image block if the ratio of skin pixels to the corresponding image block is equal to or greater than a predetermined value (0.7 in the embodiment), and regards the image block as a non-skin image block if the ratio is less than the predetermined value. Further, the alpha map block matrix generation sub-module 122a generates an M×N matrix indicating the approximate distribution form of skin pixels in the skin pixel alpha map. Each element in the matrix indicates whether the corresponding image block in the skin pixel alpha map is a skin image block (in the embodiment, a skin image block is set to 1, and a non-skin image block is set to 0).

Further, the BBP matching sub-module 122b represents the distribution form of each skin image block with respect to neighboring image blocks, based on skin image blocks, in a Block Binary Patterns (BBPs) manner newly proposed in the present invention.

Prior to the description of the BBP matching sub-module 122b, the concept and configuration of BBPs will be described with reference to related drawings.

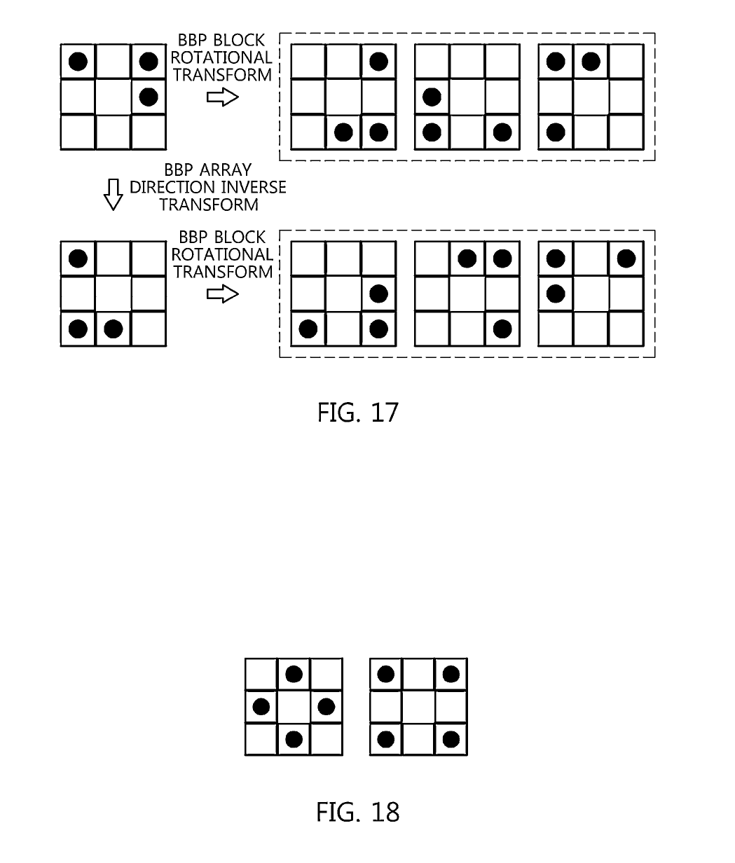

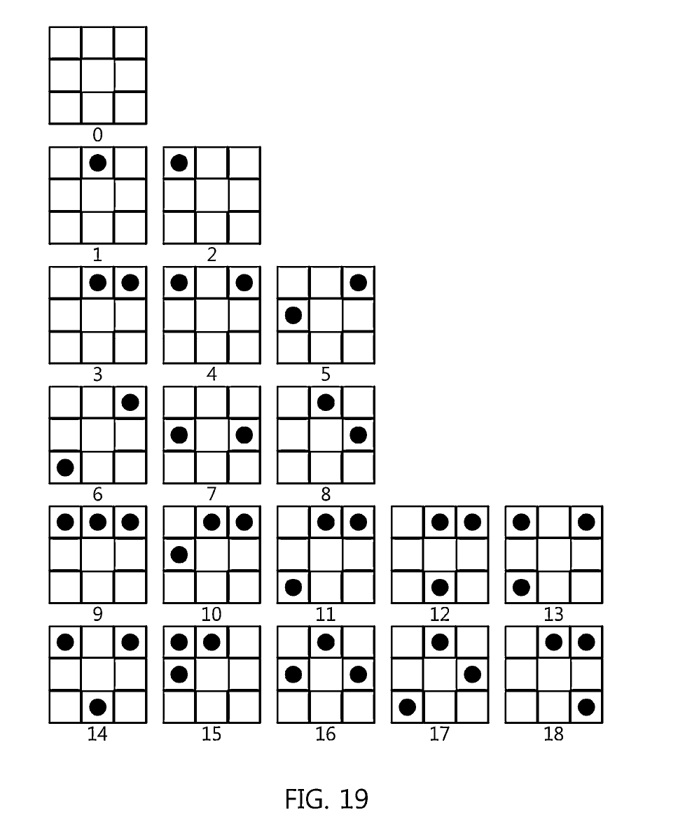

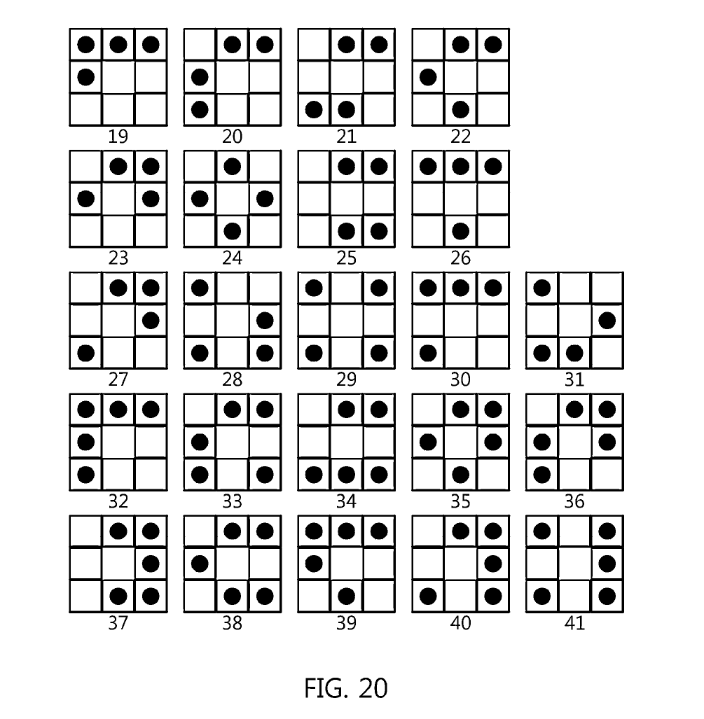

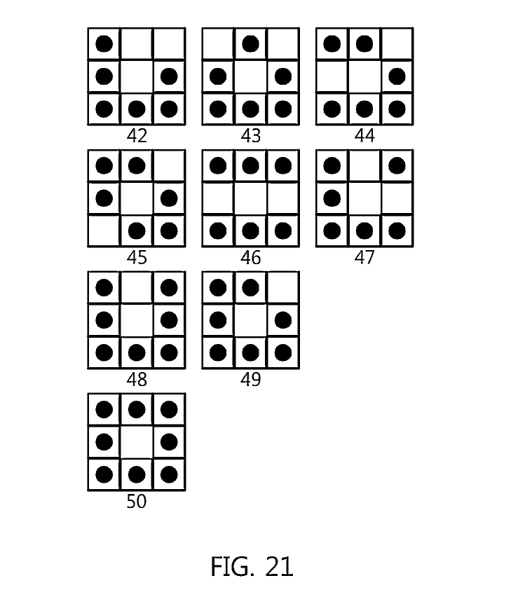

FIG. 16 is a diagram showing an inverse transform of a BBP array direction. FIG. 17 is a diagram showing the invariant property of a BBP block rotational transform and a BBP array direction inverse transform. FIG. 18 is a diagram showing Local Binary Pattern (LBP) samples regarded as non-identical. FIGS. 19 to 21 are diagrams showing 51 BBPs proposed in the present invention.

BBPs are intended to statistically represent the density characteristics of extracted skin pixels when an input image is a harmful image containing an excessively large amount of exposed human skin, and include 51 3×3 matrix patterns, as shown in FIGS. 19 to 21, in the present invention. Since BBP matching is performed only when an image block under consideration is a skin image block, it is assumed that an element in a second row and a second column is always ‘1’ and is not taken into consideration in BBP matching. That is, eight neighboring elements other than the element in the second row and the second column are not taken into consideration. That is, only eight neighboring elements other than the element in the second row and column are taken into consideration.

As shown in FIGS. 19 to 21, an element having a value of ‘1’ is indicated by a circle, and an element having a value of ‘0’ is indicated by an empty box.

When the concept of BBPs is defined, there are two types of necessary transforms, that is, a BBP block rotational transform and a BBP array direction inverse transform.

In detail, the BBP block rotational transform denotes a transform for rotating a 3×3 matrix at an angle of 90° in a clockwise or counterclockwise direction. Further, the BBP array direction inverse transform denotes a transform for inverting the array locations of eight neighboring elements from a clockwise direction to a counterclockwise direction, as shown in FIG. 16.

BBPs basically have an invariant property for the above-described BBP block rotational transform and BBP array direction inverse transform. That is, as shown in FIG. 17, locations indicated by circles in respective patterns differ from each other, but they are regarded as identical patterns upon performing BBP matching.

In contrast, two patterns shown in FIG. 18 are regarded as non-identical patterns. If it is assumed that all rotations have the invariant property as in the case of a Uniform Local Binary Pattern (ULBP), and the distances from the center of the matrix to locations in neighboring blocks are uniform, two patterns shown in FIG. 18 may be regarded as identical patterns obtained when a rotation of 45° is performed.

However, since, at the locations of rectangular blocks other than circular arcs, the ratio of distances from the center has a difference of 1:2^{1/2} in a case where neighboring blocks are present at up, down, left and right positions and a case where the neighboring blocks are preset at four corners, the blocks cannot be regarded as identical blocks. In order to reflect the characteristics of block patterns, a rotational transform having an invariant property must be limited to a 90° rotational transform.

Unless such an invariant property is used, the number of patterns representing the distribution of neighboring skin image blocks may be 2⁸, that is, 256 patterns. If, as in the case of the embodiment of image division in the above-described alpha map block matrix generation sub-module 122a, the skin pixel alpha map image is divided into 20×20 image blocks, the number of skin image blocks may be a maximum of 400 or less, and 256 storages (bins) may be excessively large upon generating a histogram required to detect statistical characteristics of density.

In order to represent the density characteristics of skin pixels while solving such a problem, invariant properties for the two types of transforms have been defined, thus consequently decreasing the number of patterns from 256 to 51. The 51 BBPs proposed in the present invention are characterized in that they have attributes indicating that the BBPs cannot overlap each other by means of the BBP block rotational transform and the BBP array direction inverse transform.

The BBP matching sub-module 122b finds the corresponding BBP by extracting a 3×3 matrix including eight neighboring elements when the element is 1 in the above-generated alpha map block matrix.

In this case, in order to include invariant properties of the BBP block rotational transform and the BBP array direction inverse transform, a maximum of eight matching operations are performed in consideration of even the transformed matrix shown in FIG. 17, for each BBP. Further, the BBP histogram generation sub-module 122C functions to calculate the number of BBPs detected as the result of BBP matching in a current alpha map block matrix, and then generate a histogram.

Further, the last module of the secondary filtering step performed by the secondary filtering unit 120, that is, the BBP-based secondary filtering module 123 considers the above-generated BBP histogram to be a feature vector having a spatial dimension of 51, compares the feature vector with preliminary knowledge acquired from the harmful image group and harmless image group of learning data, determine a possibility that the current input image will be harmful, and then filters harmless frames.

A procedure for determining a possibility of being harmful from the feature vector may be implemented using technology such as K-means clustering or a Support Vector Machine (SVM) and in the embodiment, K-means clustering was used.

The BBP-based secondary filtering module 123 has the effect of, when an input image is a harmless image and contains a large number of pixels in a color similar to a skin color, and is mistaken for a harmful candidate image at the primary filtering step performed by the primary filtering unit 110, secondarily filtering the input image using the distribution characteristics of detected skin pixels on the image plane, and transferring the frame information of images which are finally determined to be harmful candidate images to the subsequent harmfulness/harmlessness determination block, thus more precisely determining whether input images are harmful or harmless.

Hereinafter, a method of filtering harmless frames according to the present invention will be described. Repeated descriptions of technical components identical to those of the harmless frame filter 100 and the harmful image blocking apparatus 1000 according to the present invention will be omitted here.

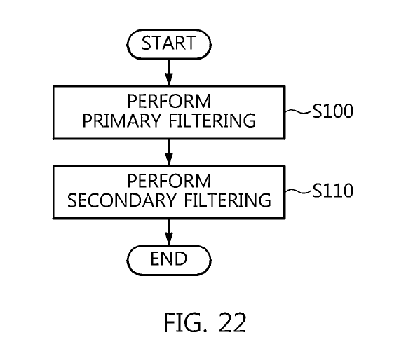

FIG. 22 is a flowchart showing a method of filtering harmless frames according to the present invention.

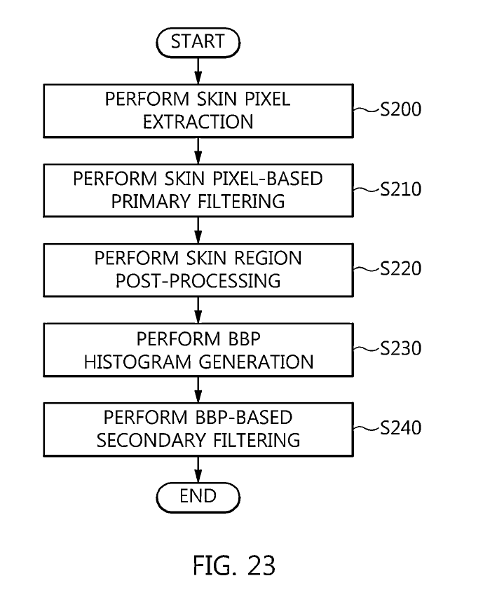

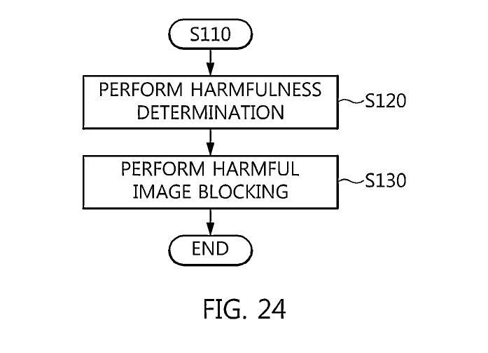

FIGS. 23 and 24 are diagrams showing embodiments of the harmless frame filtering method according to the resent invention.

Referring to FIG. 22, the harmless frame filtering method according to the present invention includes the primary filtering step S100 of extracting, by the primary filtering unit, skin region candidate pixels from an input image, and primarily filtering harmless frames based on the ratio of the skin region candidate pixels to the input image.

After primary filtering step S100, secondary filtering step S110 is performed by the secondary filtering unit, where a BBP histogram representing the distribution characteristics of the skin region candidate pixels in a 2D image space is generated and is compared with predefined learning data, thus secondarily filtering harmless frames.

Referring to FIG. 23, an embodiment of the harmless frame filtering method according to the present invention will be described. The harmless frame filtering method of the present invention includes skin pixel extraction step S200, skin pixel-based primary filtering step S210, skin region post-processing step S220, BBP histogram generation step S230, and BBP-based secondary filtering step S240.

More specifically, at skin pixel extraction step S200, by the skin pixel extraction module, RGB color information at pixels of the input image is converted into an HSV color space to generate a hue histogram, and a maximum density region in which the sum of densities is maximum on the predefined color (hue: H) channel of the hue histogram is determined to be the range of skin region candidate pixels.

Further, at the skin pixel-based primary filtering step S210, by the skin pixel-based secondary filtering module, if the maximum density sum of the maximum density region is equal to or less than a first preset value, the input image is determined to be a harmless image, whereas if the maximum density sum is greater than the first preset value, the input image is determined to a harmful candidate image, and then a binary alpha map is generated from the skin region candidate pixels.

Furthermore, at skin region post-processing step S220, by the skin region post-processing module, post-processing is performed on the alpha map, and thus a post-processed alpha map in which noise effects are corrected is generated.

Furthermore, at BBP histogram generation step S230, by the BBP histogram generation module, the distribution characteristics of skin pixels extracted from a human skin on an image plane are extracted from the post-processed alpha map, wherein the distribution characteristics of the skin pixels are differentiated from those of skin color pixels of a background region mistaken for the skin region due to similarity to a skin color.

Furthermore, at BBP-based secondary filtering step S240, by the BBP-based secondary filtering module, the BBP histogram is designated as a feature vector having a spatial dimension of 51, and is compared with predefined learning data based on K means clustering or an SVM, thus secondarily filtering harmless frames.

Referring to FIG. 24, the harmless frame filtering method according to the present invention may further include, after the secondary filtering step S110, the harmfulness determination step S120 of determining, by the harmfulness determination unit, whether the filtered input image acquired from filtering at secondary filtering step S110 is a harmful image, based on the learning data stored in the harmful content preliminary knowledge DB.

In addition, the harmless frame filtering method may further include, after harmfulness determination step S120, the harmful image blocking step S130 of accumulating and aggregating, by the harmful image blocking unit, the results of determining whether filtered input images are harmful images, determined at the harmfulness determination step S120, on a time axis, finally determining whether the image (video) currently being played is a harmful image, and then blocking the image currently being played if it is determined that the image is a harmful image.

As described above, in accordance with the harmless frame filter, the harmful image blocking apparatus having the filter, and the method of filtering harmless frames according to the present invention, there are advantages in that clearly harmless images can be rapidly determined from a plurality of input frame images and can be excluded in advance, and only images having a strong possibility of being harmful are selected, thus improving the speed of harmfulness determination that is to be subsequently and precisely performed and reducing a burden on memory.

As described above, in the harmless frame filter, the harmful image blocking apparatus having the filter, and the method of filtering harmless frames according to the present invention, the configurations and schemes in the above-described embodiments are not limitedly applied, and some or all of the above embodiments can be selectively combined and configured so that various modifications are possible.

What is claimed is:

1. A harmless frame filter, comprising:
a primary filtering unit for extracting skin region candidate pixels from an input image, and primarily filtering harmless frames, based on a ratio of the skin region candidate pixels to the input image; and
a secondary filtering unit for generating a Block Binary Pattern (BBP) histogram representing distribution characteristics of the skin region candidate pixels in a two-dimensional (2D) image space, and secondarily filtering harmless frames by comparing predefined learning data with the BBP histogram.

2. The harmless frame filter of claim 1, wherein the primary filtering unit comprises a skin pixel extraction module for converting RGB color information at pixels of the input image into a Hue, Saturation, Value (HSV) color space to generate a hue histogram, and determining a maximum density region, in which a sum of densities is maximum on a predefined hue (H) channel of the hue histogram, to be a range of the skin region candidate pixels.

3. The harmless frame filter of claim 2, wherein the primary filtering unit further comprises a skin pixel-based primary filtering module configured to:
when the maximum density sum of the maximum density region is less than or equal to a first preset value, determine the input image to be a harmless image; and
when the maximum density sum is greater than the first preset value, determine the input image to be a harmful candidate image, generate a binary alpha map from the skin region candidate pixels, and transfer the binary alpha map to the secondary filtering unit.

4. The harmless frame filter of claim 3, wherein the secondary filtering unit comprises a skin region post-processing module for performing post-processing on the alpha map and then generating a post-processed alpha map in which noise effects are corrected.

5. The harmless frame filter of claim 4, wherein the skin region post-processing module comprises:
an edge image generation sub-module for converting a color input image into a gray image, and generating an edge image using an edge operator;
an edge sum image generation sub-module for generating an edge sum image;
an edge density image generation sub-module for generating edge densities;
an alpha map filtering sub-module for determining pixels, edge densities of which are equal to or greater than a second preset value in the alpha map, to be a background region, and modifying the alpha map; and
a morphological operation sub-module for reducing noise of the alpha map by sequentially applying morphological closing and opening operations of the edge operator.

6. The harmless frame filter of claim 4, wherein the secondary filtering unit further comprises a BBP histogram generation module for extracting, from the post-processed alpha map, distribution characteristics of skin pixels extracted from a human skin on an image plane, wherein the distribution characteristics of the skin pixels are differentiated from those of skin color pixels of a background region mistaken for the skin region due to similarity to a skin color.

7. The harmless frame filter of claim 6, wherein the BBP histogram generation module comprises:
an alpha map block matrix generation sub-module for dividing the post-processed alpha map into image blocks formed as a predetermined number of matrices, and classifying each division image block as a skin image block or a non-skin image block, based on a ratio of skin pixels to the division image block;
a BBP matching sub-module for representing, based on the skin image block, a distribution form of the skin image block with respect to neighboring image blocks by 51 non-overlapping BBPs, by means of a BBP block rotational transform and a BBP array direction inverse transform; and
a BBP histogram generation sub-module for detecting a number of BBPs represented by the BBP matching sub-module and then generating a BBP histogram.

8. The harmless frame filter of claim 7, wherein the BBP matching sub-module represents 51 BBPs within a range of an alpha map having division image blocks, each BBP being represented by a 3×3 matrix in which an element corresponding to a second row and a second column is a skin image block.

9. The harmless frame filter of claim 1, wherein the secondary filtering unit comprises a BBP-based secondary filtering module for designating the BBP histogram as a feature vector having a spatial dimension of 51, and comparing the feature vector as the predefined learning data based on K-means clustering or a Support Vector Machine (SVM), thus secondarily filtering harmless frames.

10. A harmful image blocking apparatus, comprising:
a harmfulness determination unit for determining, for filtered input images obtained by filtering harmless frames using the harmless frame filter as set forth in claim 1 , whether the filtered input images are harmful images, based on learning data stored in a harmful content preliminary knowledge database (DB); and
a harmful image blocking unit for accumulating and aggregating results of determination performed by the harmfulness determination unit about whether the filtered input images are harmful images on a time axis, finally determining whether an image currently being played is a harmful image, and blocking the image if it is determined that the image is a harmful image.

11. A method of filtering harmless frames, comprising:
performing, by a primary filtering unit, primary filtering by extracting skin region candidate pixels from an input image, and by primarily filtering harmless frames, based on a ratio of the skin region candidate pixels to the input image; and
performing, by a secondary filtering unit, secondary filtering by generating a Block Binary Pattern (BBP) histogram representing distribution characteristics of the skin region candidate pixels in a two-dimensional (2D) image space, and by comparing predefined learning data with the BBP histogram to secondarily filter harmless frames.

12. The method of claim 11, wherein performing the primary filtering comprises performing skin pixel extraction by converting RGB color information at pixels of the input image into a Hue, Saturation, Value (HSV) color space to generate a hue histogram and by determining a maximum density region, in which a sum of densities is maximum on a predefined hue (H) channel of the hue histogram, to be a range of the skin region candidate pixels.

13. The method of claim 12, wherein performing the primary filtering further comprises, after performing the skin pixel extraction, performing skin pixel-based primary filtering by:
when the maximum density sum of the maximum density region is less than or equal to a first preset value, determining the input image to be a harmless image, and
when the maximum density sum is greater than the first preset value, determining the input image to be a harmful candidate image, and generating a binary alpha map from the skin region candidate pixels.

14. The method of claim 13, wherein performing the secondary filtering comprises performing skin region post-processing by performing post-processing on the generated alpha map, and then generating a post-processed alpha map in which noise effects are corrected.

15. The method of claim 14, wherein performing the skin region post-processing comprises:
converting a color input image into a gray image, and generating an edge image using an edge operator;
generating an edge sum image;
generating edge densities;
determining pixels, edge densities of which are equal to or greater than a second preset value in the alpha map, to be a background region, and then modifying the alpha map; and
reducing noise of the alpha map by sequentially applying morphological closing and opening operations of the edge operator.

16. The method of claim 14, wherein performing the secondary filtering further comprises, after performing the skin region post-processing:
performing BBP histogram generation by extracting, from the post-processed alpha map, distribution characteristics of skin pixels extracted from a human skin on an image plane, wherein the distribution characteristics of the skin pixels are differentiated from those of skin color pixels of a background region mistaken for the skin region due to similarity to a skin color.

17. The method of claim 16, wherein performing the BBP histogram generation comprises:
dividing the post-processed alpha map into image blocks formed as a predetermined number of matrices, and classifying each division image block as a skin image block or a non-skin image block, based on a ratio of skin pixels to the division image block;
representing, based on the skin image block, a distribution form of the skin image block with respect to neighboring image blocks by 51 non-overlapping BBPs, by means of a BBP block rotational transform and a BBP array direction inverse transform; and
detecting a number of represented BBPs and then generating a BBP histogram.

18. The method of claim 17, wherein representing the distribution form comprises representing 51 BBPs within a range of an alpha map having division image blocks, each BBP being represented by a 3×3 matrix in which an element corresponding to a second row and a second column is a skin image block.

19. The method of claim 11, wherein performing the secondary filtering comprises, after generating the BBP histogram, designating the BBP histogram as a feature vector having a spatial dimension of 51, and comparing the feature vector as the predefined learning data based on K-means clustering or a Support Vector Machine (SVM), thus secondarily filtering harmless frames.

20. The method of claim 11, further comprising, after performing the secondary filtering:
determining, for filtered input images, obtained by performing the secondary filtering, whether the filtered input images are harmful images, based on learning data stored in a harmful content preliminary knowledge database (DB); and
accumulating and aggregating results of the determination about whether the filtered input images are harmful images on a time axis, finally determining whether an image currently being played is a harmful image, and blocking the image if it is determined that the image is a harmful image.
